(19) United States
(12) Patent Application Publication
(10) Pub. No.: US 2018/0180365 A1
(43) Pub. Date: Jun. 28, 2018

(54) SYSTEM FOR INTERCEPTING AND COLLECTING CLEANING BODIES BY ALTERNATING SWEEPING

(71) Applicant: E. BEAUDREY & CIE, PARIS (FR)

(72) Inventor: Philip Eugène, Douglas JACKSON, Paris (FR)

(21) Appl. No.: 15/739,342

(22) PCT Filed: Jun. 24, 2016
(86) PCT No.: PCT/FR2016/051563

§ 371 Date: Dec. 22, 2017

(30) Foreign Application Priority Data
Jun. 26, 2015 (FR) 15 55939

(51) Int. Cl. F28G 1/12; F28G 15/00; F16L 55/24; B01D 29/01; B01D 29/64; B08B 1/04

(52) U.S. Cl. CPC F28G 1/12; F28G 15/00; F16L 55/24; F16L 2101/12; B01D 29/6484; B08B 1/04; F28G 2015/006; B01D 29/014

(57) ABSTRACT

The invention concerns a system for intercepting and collecting bodies in a flow of a fluid, comprising:
a pipe portion (18) comprising an inner face that defines an axial inner passage for the flow,
a filtering surface (25) including an upstream face (25a) and extending transversely in the passage so as to intercept, by its upstream face, bodies conveyed by the flow whilst leaving exposed a plurality of collection openings (26a, 26b) between the filtering surface and the inner face,
a cleaning device (30) that is arranged across from the upstream face (25a), the device (30) and the filtering surface (25) being in motion with respect to one another such that each zone of the upstream face is mechanically swept by the device during each alternating relative back and forth movement in order to orient the bodies intercepted by the upstream face (25a) toward the collection openings for said bodies.

The present invention relates generally to the interception and collection of bodies conveyed by a flow of a fluid.

The present invention relates more particularly to cleaning heat exchangers, for example tubular heat exchangers forming condensers.

Exchangers are generally cleaned continuously by solid cleaning elements or cleaning bodies, in practice ball-shaped and made for example of foam rubber, conveyed by one of the flows concerned in accordance with arrangements known in principle for a long time, notably from U.S. Pat. No. 1,795,348.

These cleaning bodies are generally intercepted by an interception system that it is necessary to dispose on the outlet pipe of the heat exchanger to recover these cleaning bodies there and to re-inject them into the inlet pipe of the exchanger.

The overall interception system includes inside a sleeve filtration means appropriate for the required retention.

At present, and in accordance with various practical embodiments, these filtration means are usually formed of two flat grids which in their service position transversely close the sleeve, together forming a dihedron the edge of which perpendicular to its axis is oriented in the downstream direction. In practice, each of these two grids is individually mounted to pivot in the median zone of their axes parallel to this edge so as to be able to occupy one or the other of two other positions, namely:
a cleaning position, which is the reverse of their service position, and in which they can be subjected to a washing counterflow, and
another position between their service position and their cleaning position and in which they are disposed in the flow and in practice out of service.

To ensure proper rolling of the cleaning bodies over the grids in the direction of means for collecting said bodies provided along the edge of these grids said grids are necessarily inclined at a relatively small angle to the axis of the sleeve when in the service position.

The result of this is that, to accommodate the grids, this sleeve is necessarily relatively long.

Also, when the grids are pivoted for the cleaning operation a number of cleaning bodies trapped under the grids are returned to the natural environment, often infringing regulations applicable to waste material.

It can prove difficult to install an interception system equipped in this way with grids of this kind, in particular in some pre-existing installations in which there is available only a short length of channel between the outlet of the heat exchanger and the masonry structure on which the latter rests.

To alleviate these disadvantages it has been proposed to use instead and in place of a sleeve with pivoting grids a filter with circular filter elements perpendicular to the axis of the sleeve and a suction system for aspirating cleaning bodies stopped by the filter. The suction system recovers the stopped bodies by aspirating them by means of a pump that thereafter returns them to a point upstream of the inlet of the exchanger. This system is the subject of French patent n^{o} 94 02109. Effective and not allowing any cleaning bodies to pass, this device however necessitates a pump of relatively large flow rate (at least 4% of the principal flow) that is bulky, costly and greedy of energy. Moreover, the high flow rate necessitates pipes of relatively large diameter, which are also costly and bulky.

The invention is intended to alleviate at least one of the aforementioned disadvantages by proposing, in accordance with a first aspect, a system for intercepting and collecting bodies conveyed by a flow of a fluid, comprising:
a pipe portion characterized in that it comprises an inner face that defines an axial inner passage for the flow of the fluid,
at least one filtering element comprising a filtering surface including a first upstream face and a second opposite downstream face, the filtering surface extending transversely in the inner passage so as to intercept, by its first upstream face, bodies conveyed by the flow whilst leaving exposed a plurality of collection openings between the filtering surface and the inner face of the pipe portion,
a cleaning device that is arranged across from the first upstream face of the filtering surface and that is able to sweep said first upstream face mechanically, the cleaning device and said at least one filtering element being in alternating relative back and forth motion with respect to one another such that each zone of the first upstream face of the filtering surface is swept mechanically by the cleaning device during each alternating relative back and forth movement in order to orient the bodies intercepted by the first upstream face from the filtering surface toward the collection openings for said bodies.

This mechanical sweeping of the filtering surface by relative movement of that surface and the cleaning device makes it possible to dislodge bodies stopped by the latter by a mechanical action of contact between the bodies and the cleaning device (or by contact with at least one mechanical sweeping member of the device that is intended to rub or scrape against the filtering surface) and to move them by pushing them, still by mechanical contact, toward the collection openings (e.g. lateral openings). Sweeping is effected in a first direction of movement of the filtering surface of the cleaning device in order to sweep the surface a first time by mechanical rubbing between the cleaning device and the upstream face of the surface (outward direction) then in a second direction of movement in order to sweep the same surface (return direction). The sweeping movement is therefore an alternating back and forth movement (this movement can be effected once or repeated consecutively a number of times) of one of the two elements (surface or cleaning device) relative to the other with mechanical rubbing contact maintained between the two elements. This interception and collection system is therefore particularly simple and effective and makes it possible not to use a system like that of the prior art described above in which the cleaning bodies intercepted by the filtering surface are collected only by necessarily very powerful suction (here no suction flow is necessary). The system according to the invention therefore necessitates no high flow rate suction pump (at least 4% of the principal flow) that is bulky, costly and greedy of energy, as in the prior art described above. Because of this it is no longer necessary to provide pipes of large diameter, which are also costly and bulky.

Also, the mechanical sweeping of the filtering surface that is effected by the system also cleans said surface.

According to other possible features considered separately or in combination with one another:
the filtering surface has a general shape that extends transversely (and possibly axially depending on the shape adopted) in the inner passage such that the bodies intercepted on a zone of the first upstream face of the filtering surface and swept by the cleaning device run alongside said first upstream face from the filtering surface toward one or more collection openings (in moving toward one or the other of the opposite peripheral ends or edges thereof in the direction of collection openings);
the collection openings are arranged so as to be adjacent to two opposite peripheral edges of the filtering surface; these two opposite edges are disposed along a transverse axis of the filtering surface and the latter has, along another perpendicular transverse axis, two other opposite peripheral edges that are disposed at a distance from the internal face of the pipe portion that does not allow to pass the cleaning bodies conveyed by the flow;
the system comprises, at each of the two opposite peripheral edges of the filtering surface, at least one collection hopper for the bodies arranged downstream from at least one collection opening and communicating with said at least one collection opening; thus one or more hoppers can be disposed on each side of the filtering surface, between the latter and the inner face of the pipe portion;
each collection hopper for the bodies forms a vortex chamber including at the inlet at least one obstacle that is able to generate fluid vortices in the chamber when a flow of fluid encounters said at least one obstacle; the effect of the generation of vortices in the chamber or chambers is to maintain the bodies in movement inside the latter, thus preventing any stagnation or jamming of said bodies;
the filtering surface has a general shape chosen from among the following geometric shapes: a semi-cylindrical surface whereof the concave inner face corresponds to the first upstream face, a semi-cylindrical surface whereof the convex outer face corresponds to the first upstream face, a planar surface formed by a panel substantially perpendicular to the axis of the pipe portion; these examples of shapes are particularly suitable for the interception and the collection of the bodies in an efficient manner and their mechanical sweeping by the cleaning device during the alternating back and forth movement;
when the filtering surface is a semi-cylindrical surface whereof the concave inner face corresponds to the first upstream face, at least one collection opening of the bodies is arranged on either side of said filtering surface, between the inner face of the pipe portion and a peripheral edge of the filtering surface, at least one collection hopper of the bodies being arranged downstream from said at least one collection opening;
the pipe portion also comprises the mechanical cleaning device; the system housing the filtering element and the cleaning device in the pipe portion in this way is particularly compact and therefore has a relatively small overall size in the axial direction; when the filtering surface is a semicylindrical surface the inner face of which corresponds to the first upstream face the cleaning device is housed in the half-cylinder delimited by the filtering grid (radially arranged relative to the half-cylinder), which confers on the system a particularly small overall size in the axial direction;
the pipe portion has a cross section of polygonal or circular shape; the polygonal shape which can for example cover a rectangular general shape is particularly suitable for housing a filter element the filtering surface of which is semicylindrical; the circular shape can be used to house a filtering element that has, as seen in a transverse direction, a rectangular general shape; in a perpendicular axial section the filtering element can have for example a curved (e.g. semicylindrical) or plane shape;
the pipe portion having a circular cross-section, the system comprises a deflection assembly (deflector assembly) that is positioned between the inner face of the pipe portion and the filtering surface in order to steer, toward the filtering surface (toward the first upstream face of the surface), the bodies conveyed by the flow and that are not situated across from the filtering surface;
the deflection assembly comprises at least one deflector that is positioned between the inner face of the pipe portion and the collection opening(s) arranged so as to be adjacent to each of the two opposite peripheral edges of the filtering surface (for example, the surface can have a semicylindrical shape the concave inner face of which is the first upstream face); thus at least one deflector is positioned on each side of the filtering surface; said at least one deflector is able directly to redirect the bodies moving along the inner face of the wall that encounter said at least one deflector either directly toward the adjacent collection opening or openings or toward the filtering surface situated on the other side of the collection opening or openings, depending on the speed and the trajectory of the bodies; it will be noted that at least one other deflector can be positioned between the inner face of the pipe portion and each of the opposite peripheral two other edges of said filtering surface adjacent the first opposite two peripheral edges of said filtering surface;
the cleaning device is mobile while said at least one filtering element is stationary; alternatively, said at least one filtering element is mobile while the cleaning device is stationary;
one from among the cleaning device and said at least one filtering element is able to perform a pivoting movement around a fixed axis or to perform a rectilinear translational movement, each movement being an alternating back and forth movement;
the cleaning device comprises one or several mechanical sweeping members that are in contact with the first upstream face of the filtering surface; this member is or these members are maintained in contact with the filtering surface in the rest position, i.e. when there is no movement of the device or the surface;
the filtering surface extends in two mutually perpendicular transverse directions, the mechanical sweeping member or members extending transversely in one of the two transverse directions and over all the corresponding dimension of the first upstream face;
the mechanical sweeping member or members extends or extend parallel to the two opposite peripheral edges of the filtering surface;
the filtering surface is formed by a filtration grid with bars defining between them openings through which the fluid flows and in which bodies are liable to be lodged, the mechanical sweeping member or members being able, in contact with the first upstream face of the filtering surface, to penetrate at least partly into the openings of the grid in order to dislodge any bodies lodged there;
the mechanical sweeping member or members can take the form of a brush, a comb or any other member capable of pushing the elements stopped on the surface toward the collection openings;
in one application the bodies conveyed by the flow are heat exchanger cleaning bodies.

According to another application, the aim of the system is to filter bodies such as debris and other undesirable elements conveyed by the flow. For example this system can therefore be disposed on the upstream side of any installation, a heat exchanger, . . . .

According to a second aspect, the invention is also directed to an installation comprising:
at least one tubular heat exchanger,
a fluid feed pipe connected to an inlet of said at least one heat exchanger,
a fluid evacuation pipe connected to an outlet of said at least one heat exchanger,
a plurality of cleaning bodies conveyed inside said at least one heat exchanger to clean it,
a system for intercepting and collecting the cleaning bodies disposed on the fluid evacuation pipe, characterized in that the system for intercepting and collecting cleaning bodies is the system as briefly described above.

An aim of the system is therefore to intercept in a simple and efficient manner and with lower energy expenditure than the aforementioned prior art the cleaning bodies that have been used to clean said at least one exchanger and to collect them in order to return them to circulation in the installation, on the upstream side of said at least one exchanger, or to replace them.

According to a third aspect, the invention is further aimed at a method for collecting bodies conveyed by a flow of a fluid, characterized in that the method is carried out in a system for intercepting bodies conveyed by the fluid flow that comprises:
a pipe portion comprising an inner face that defines an axial inner passage for the flow of the fluid,
at least one filtering element comprising a filtering surface including a first upstream face and a second opposite downstream face, the filtering surface extending transversely in the inner passage so as to intercept, by its first upstream face, bodies conveyed by the flow while leaving several collection openings clear between the filtering surface and the inner face of the pipe portion,

the method comprising the following step:
setting said at least one filtering element or a cleaning device in motion with respect to said at least one filtering element in an alternating back and forth movement in order to perform mechanical sweeping of each zone of the first upstream face of the filtering surface by contact with the cleaning device opposite, the mechanical sweeping of the surface making it possible to orient the bodies intercepted by the first upstream face from the filtering surface toward the collection openings of said bodies.

According to one possible feature:
the cleaning device is set in motion while said at least one cleaning element is stationary or vice versa.

The features of the first and second aspects of the invention described above apply equally to the third aspect of the invention briefly described above.

Other features and advantages will become apparent in the course of the following description, given by way of nonlimiting example only and with reference to the appended drawings, in which:

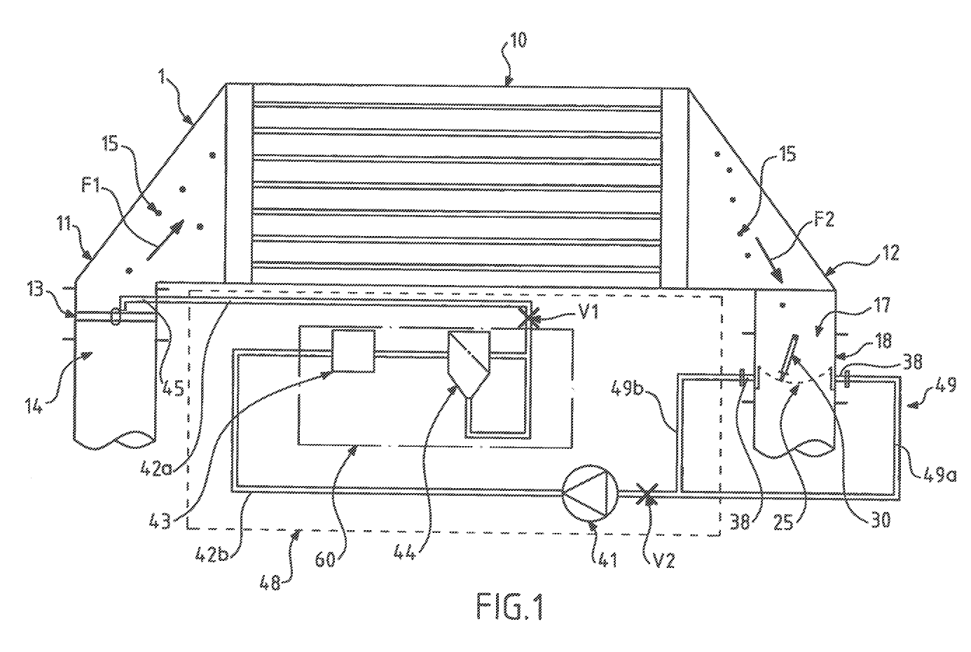

FIG. 1 is a diagrammatic general view of an installation comprising an exchanger and a system in accordance with one embodiment of the invention for intercepting and collecting cleaning bodies;

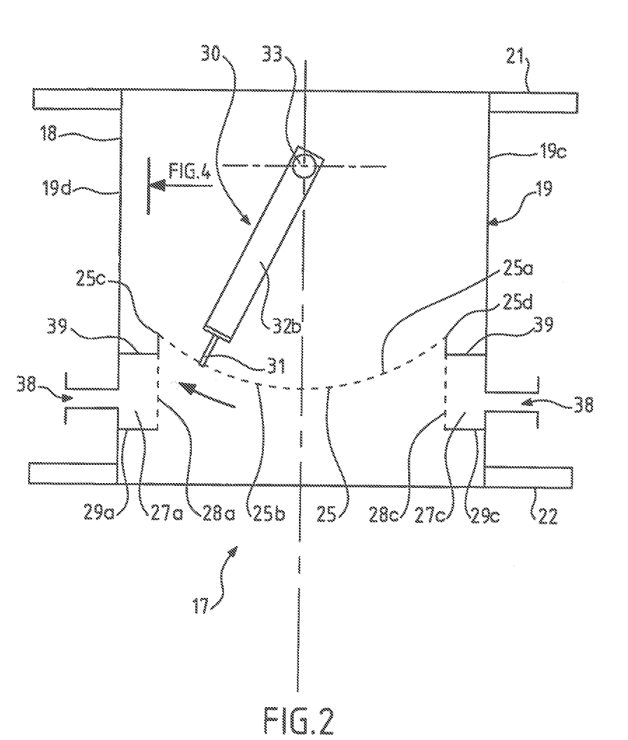

FIG. 2 is a detailed view to a larger scale and in section on an axial plane of the installation for intercepting and collecting cleaning bodies of the installation from FIG. 1;

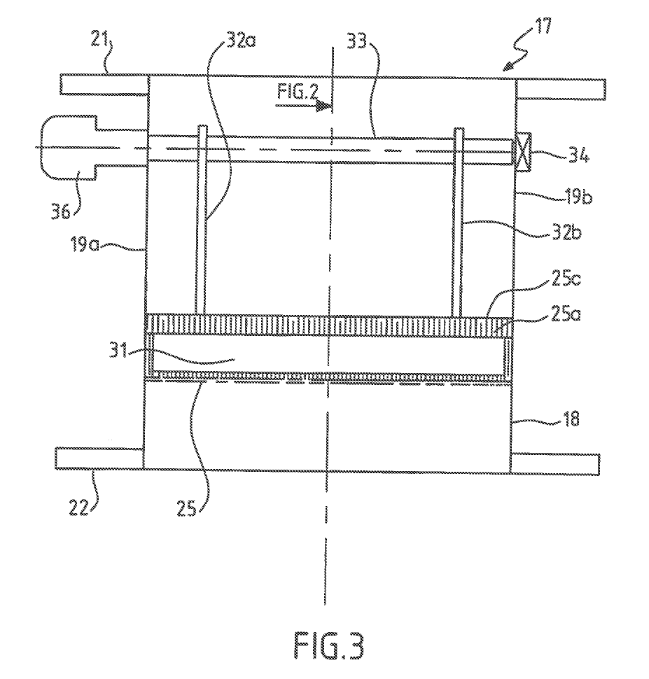

FIG. 3 is a view in axial section of the system from FIG. 2 on a plane perpendicular to the plane of FIG. 2 and containing the axis of the pipe portion;

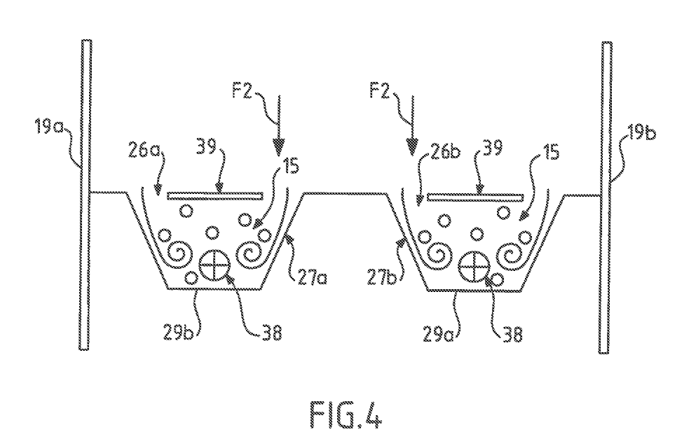

FIG. 4 is a diagrammatic view to a larger scale in section on the section plane in FIG. 2 of the gutter for collecting intercepted cleaning bodies;

FIG. 5 is a view in section on an axial plane of a first variant of a system for intercepting and collecting cleaning bodies in which the filtering element is plane;

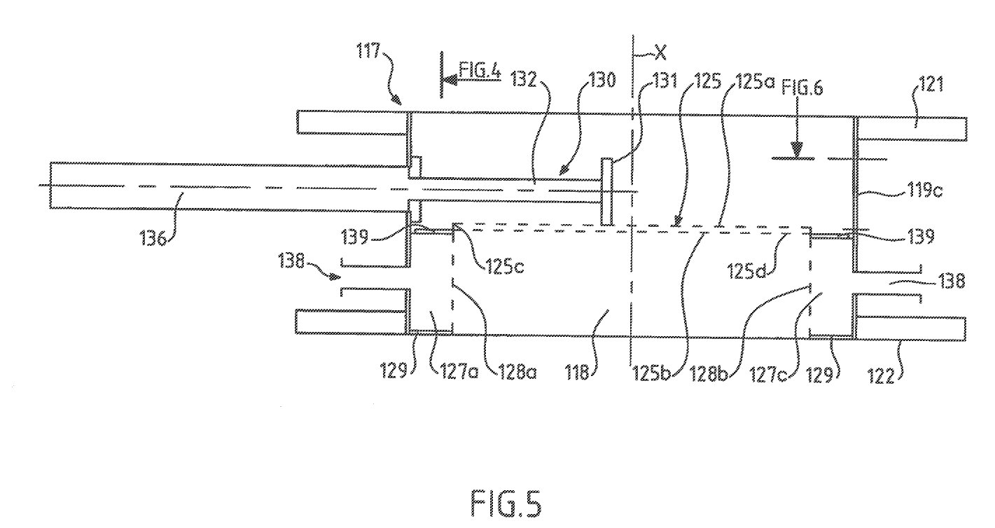

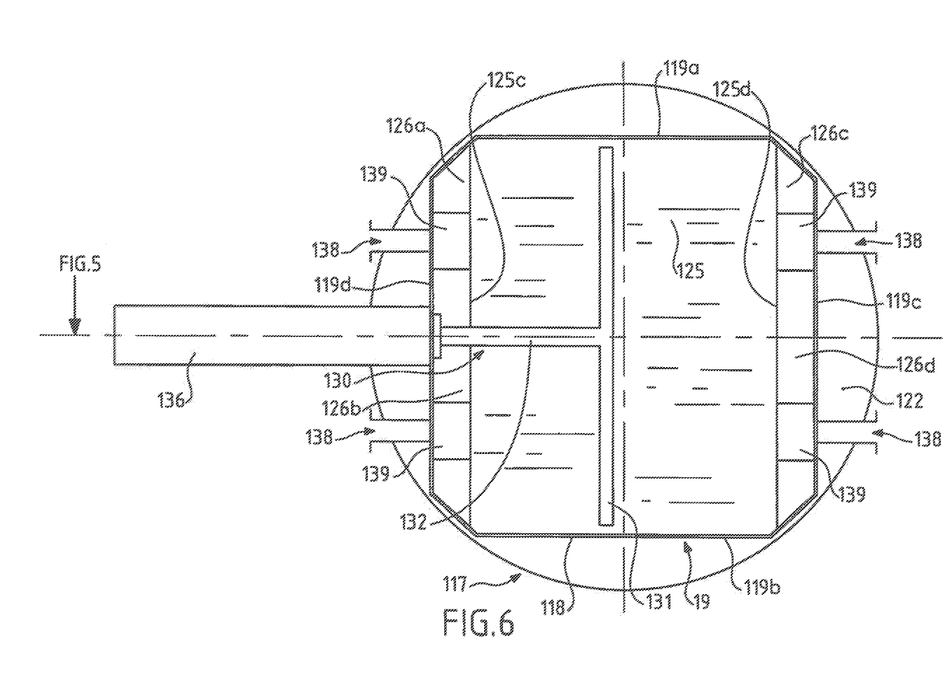

FIG. 6 is a view in section of the system from FIG. 5 on a plane perpendicular to the plane of that Figure and to the axis of the pipe portion;

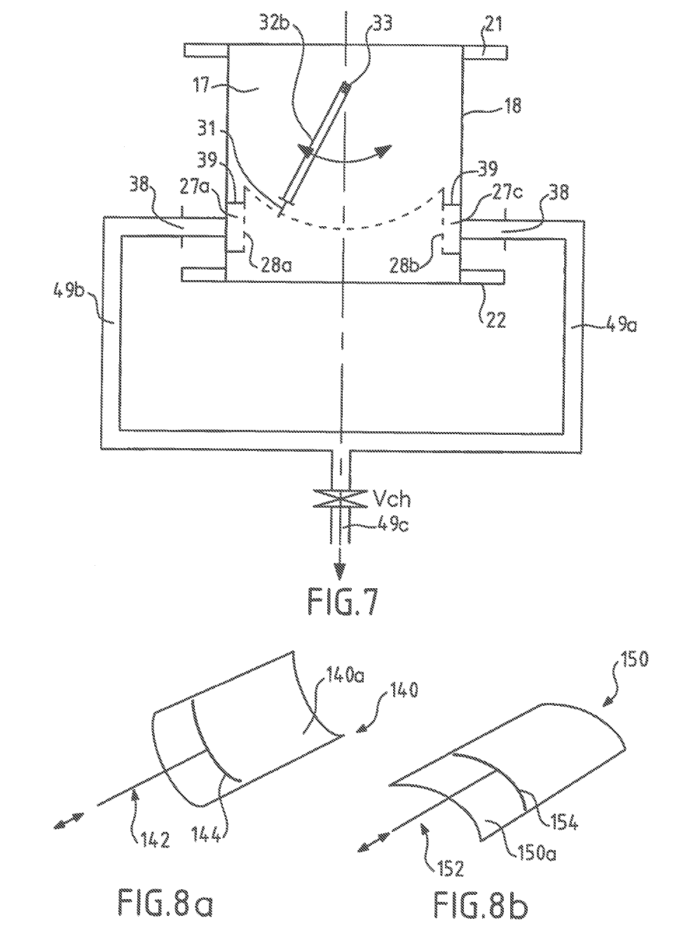

FIG. 7 is a diagrammatic view of the interception system from FIGS. 1 to 4 used as a filter;

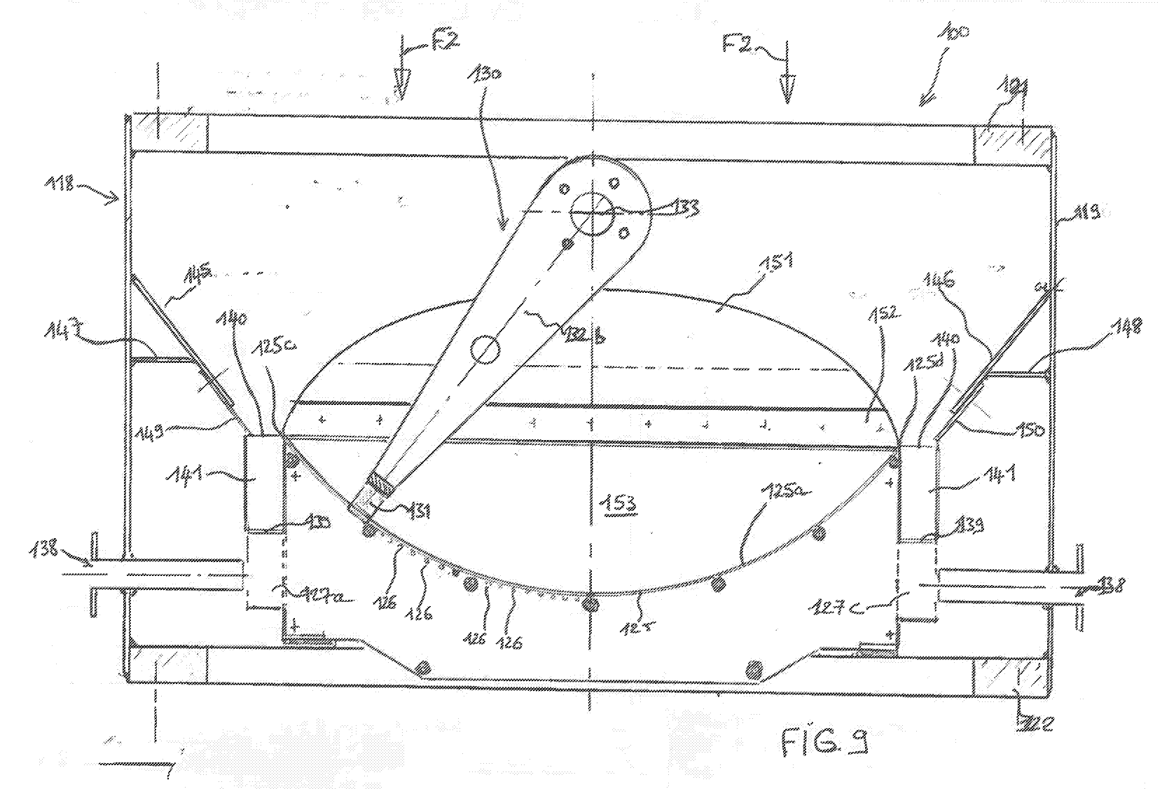

FIG. 8a is a diagrammatic partial perspective view of a second variant of a system for intercepting and collecting cleaning bodies;

FIG. 8b is a diagrammatic partial perspective view of a third variant of a system for intercepting and collecting cleaning bodies;

FIG. 9 is a diagrammatic view in section on an axial plane of a fourth variant of a system for intercepting and collecting cleaning bodies.

In FIG. 1 is shown diagrammatically, with the general reference denoted 1, an installation according to one embodiment of the invention that comprises a plurality of elements including a heat exchanger forming a condenser 10. As shown diagrammatically by the arrows F1 and F2, there flows through this exchanger a flow of cooling fluid, in this instance water, by way of on the one hand an inlet or fluid feed pipe 11 (inlet flow F1) and on the other hand an outlet or fluid evacuation pipe 12 (outlet flow F2).

In practice this is a tubular heat exchanger which is for example of the type briefly described in the document FR 2 716 530 mentioned above.

A heat exchanger 10 of this kind being well known in itself and not as such forming part of the present invention, it will not be described further here.

In the embodiment shown filtering means 13 are disposed on the inlet pipe 11 inside a sleeve 14.

These filtering means 13, which are not mandatory, are not part of the present invention either and will therefore not be further described here.

They are for example filtering means of the type described in the document FR 2 609 644.

In a manner known in itself cleaning bodies in the form of solid cleaning elements 15 can be circulated continuously in the installation 1 and in particular in the heat exchanger 10 to clean the latter continuously.

These are in practice foam rubber balls the diameter of which is slightly greater than the inside diameter of the tubes of the heat exchanger 10 and the density of which, when impregnated, is similar to that of water.

It is necessary to provide for management of these cleaning bodies 15 in the installation 1, i.e. not only to ensure their effective circulation in the heat exchanger 10 but also to control the number of them and where applicable their dimensions (thus making it possible where appropriate to eliminate bodies that are too worn).

In a manner known in itself these cleaning bodies 15 are systematically injected into the inlet pipe 11 downstream of the filtering means 13 to be entrained by the inlet flow F1.

The installation 1 also comprises, mounted on the outlet pipe 12, a system 17 in accordance with one embodiment of the invention for intercepting and collecting the circulating cleaning bodies 15. This system is described in more detail hereinafter.

The installation 1 further comprises, inside dashed lines in FIG. 1, a system 48 for management of the intercepted and collected cleaning bodies that recycles the cleaning bodies 15 retained by the interception system 17 to the inlet pipe 11.

In a manner known in itself the management system 48 comprises a recycling pipe 49 (pipe portions 49a and 49b in this example) connected on one side to the interception system 17 and on the other side to the suction side of a pump 41 (suction device), the pump being connected to a return pipe 42a via, successively, a pipe 42b, a meter 43 and a manifold 44. The return pipe 42a feeds the inlet pipe 11 downstream of the filtering means 13 with cleaning bodies 15 to be returned to circulation in the installation. These cleaning bodies 15 are reinjected via injection pipes or nozzles 45 that are preferably oriented in contraflow.

A valve V1 enables the flow in the pipe 42a downstream of the manifold 44 to be cut off to isolate said manifold 44 and the meter 43 in collaboration with a valve V2 that enables the pump 41 to be isolated from the interception system 17.

The system for intercepting and collecting the cleaning bodies 17 is installed downstream of the tubular exchanger 10 on the generally circular pipe 12 and comprises a pipe portion or sleeve 18 that comprises an inlet flange 21 and an outlet flange 22 (FIGS. 2 and 3).

The sleeve 18 has an inner face that delimits an axial internal passage for the flow of fluid coming from the exchanger 10.

The interior of the flanges 21 and 22 is cut so as to provide the junction with a central body 19 which here has a polygonal cross section. In other embodiments the cross section of the body assumes other shapes. This body 19 is of substantially rectangular cross section and can have the four corners cut off. The body 19 includes four plane faces 19a and 19b, 19c and 19d opposite in pairs.

The system 17 includes, centrally installed inside the sleeve 18, in particular inside the body 19, a filtering element 25 that comprises a filtering surface here extending both transversely and axially in the axial internal passage of the body 19.

As shown in FIG. 2, the filtering surface includes a upstream first face 25a directed toward the exchanger 10 and an opposite downstream second face 25b.

In the embodiment shown in FIGS. 1 to 3 the filtering surface has a semicylindrical general shape with the concavity of the half-cylinder (inner face) facing toward the upstream side of the sleeve 18 (and therefore the pipe 12). The axis of the half-cylinder is perpendicular to the two opposite faces 19a and 19b of the body (FIG. 3). The filtering surface takes the form of a grid of bars placed in the flow of fluid coming from the pipe 12 and that occupies almost all of the internal passage section of the sleeve 18 so as to intercept the cleaning bodies 15 conveyed by the flow on the upstream face 25a of the grid.

One or more openings for collecting the bodies 15 are disposed on each of the two opposite peripheral sides or edges of the half-cylinder, between each upstream free edge/end 25c, 25d of the half-cylinder and the facing inner face of the sleeve 18. Two collection openings 26a, 26b are shown in FIG. 4 disposed one beside the other between the two opposite faces 19a, 19b of the body 19, in the vicinity of the edge 25c of the half-cylinder. Two other openings (not shown) are disposed symmetrically in the vicinity of the opposite edge 25d of the half-cylinder 25. Thus the filtering surface 25 occupies almost all the passage section offered to the flow and to the conveyed bodies 15 except for the lateral collection openings 26a, 26b on the side of the edge 25c of the half-cylinder 25 and those not shown on the side of the opposite edge 25d. The filtering surface extends in particular in two mutually perpendicular transverse directions as well as in an axial direction perpendicular to the first two directions. The two opposite peripheral edges of the filtering surface that are adjacent to the collection openings are spaced from each other in a first of the two transverse directions in which the filtering surface extends.

The system 17 also includes behind and downstream of each collection opening a hopper for collecting the bodies 15 (FIGS. 2 and 4). Two hoppers 27a, 27b are shown in FIG. 4, one beside the other between the two opposite faces 19a and 19b, and only the hopper 27a can be seen in FIG. 2. Two identical hoppers are disposed symmetrically on the opposite side of the filtering surface and only the hopper 27c can be seen in FIG. 2.

Each collection hopper forms a vortex chamber including at the inlet, where the collection opening is situated, an obstacle 39 (for example a deck plate) that is adapted to generate, when a fluid flow F2 (coming from the pipe 12) encounters said obstacle, fluid vortices downstream of the obstacle, i.e. in the chamber as shown in FIG. 4.

Such vortex hoppers are for example of the type described in French patent N^{o} 8210055.

Each of the hoppers has one of its two opposite sides perforated and formed by a perforated side panel 28a, 28c (FIG. 2) extending axially from the respective peripheral edge 25c, 25d of the filtering surface to the respective bottom 29a, 29c of the hopper. Thus in FIG. 2 the hopper 27a is delimited on one side by the perforated side panel 28a and on the opposite side by the opaque face 19d whilst the hopper 27c is delimited on one side by the opposite perforated side panel 28c and on the opposite side by the opaque face 19c.

An outlet tube 38 is provided for each body collection hopper (FIGS. 2 and 4) in the corresponding opaque face 19d, 19c and is connected to the two branches 49b, 49a respectively of the recycling pipe 49 (FIG. 1).

The system 17 comprises a cleaning device 30 inside the sleeve, in particular the body 19, and disposed facing the upstream first face 25a of the filtering surface, i.e. inside the half-cylinder.

This device 30 includes one or more mechanical sweeping members 31. The device is mounted inside the sleeve so that the mechanical sweeping member or members 31 comes or come into contact with the upstream first face 25a, both at rest and during the sweeping movement to be described later in order to rub/scrape the filtering surface during the movement.

In the example described and shown the device 30 includes only one mechanical sweeping member 31 but the following description applies equally in the case of a plurality of members.

The member 31 is for example a brush, a flexible squeegee, a comb . . . or any other member that is capable of exerting a mechanical rubbing action on the upstream first face of the filtering surface when relative movement between the member and the surface is imposed by the design of the system. Two possibilities are offered to enable rubbing of the member 31 over the filtering surface: either the member moves or the surface moves. In the following example only the cleaning device is mobile, the filtering surface being stationary. However, the following description applies equally to the other possibility: stationary cleaning device and mobile filtering surface.

The mechanical sweeping member 31 is carried by one or more arms, namely two arms 32a, 32b in the embodiment shown in FIG. 3. The parallel arms 32a, 32b are themselves coupled to a shaft 33 that is coaxial with the axis of the half-cylinder 25 (grid) and parallel to the direction in which the member 31 extends. This direction in which the member 31 extends is parallel to the peripheral edges 25c, 25d and the member 31 extends transversely (FIG. 3) over all the corresponding transverse dimension of the surface, with the exception of a narrow space between each end of the member and the facing face 19a, 19b for reasons of assembly and of freedom of movement of the member 31 when it moves. The shaft 33 is mounted at its two opposite ends on the two opposite faces 19a, 19b of the body 19 (FIG. 3) and pivots on itself, being carried by a bearing 34 fixed to the face 19b of the body. At the level of the opposite face 19a of the body the shaft 33 is connected to a drive system 36 known in itself that drives it in rotation on command. This system 36 is for example a motor. The drive system 36 drives the shaft 33 in rotation and therefore imparts to the mechanical sweeping member 31 an alternating back and forth rotation or oscillating movement (each back and forth movement is effected over the same angular sector the amplitude of which is equal to the circular arc shown by the filtering surface 25 in FIG. 2), enabling it to sweep all the upstream first face 25a of the filtering surface 25 from the edge 25d to the edge 25c, then from the edge 25c to the edge 25d, and to exert a mechanical rubbing action on each area of the latter on each pass. When the sweeping member is a brush, a broom, . . . , the bristles thereof partly penetrate into the openings situated between the bars of the grid (the rest position of the device 30 is adjusted to allow this arrangement), which makes it possible to dislodge bodies that have been able to lodge in the openings of the grid.

The rotation movement allows the mechanical sweeping member 31 to detach/unstick by rubbing the cleaning bodies and other elements stopped on the upstream face 25a of the grid 25.

During the same back and forth movement the rotation movement then allows the member 31 to push the cleaning bodies and other detached/unstuck elements in the direction of one of the two peripheral edges 25c, 25d (here the edge 25c in FIG. 2), along the upstream face 25a as shown in FIG. 2 (the arrow indicates the direction of rotation of the device 30).

The rotation movement continuing, the bodies 15 and other detached/unstuck elements reach the collection openings 26a, 26b adjacent the edge 25c and situated upstream of the hoppers 27a and 27b respectively (FIG. 4) and pass through them to be collected in said hoppers.

The cleaning device 30 then begins to move in the opposite rotation direction, starting from the edge 25c in order to travel the same semicircular portion as far as the opposite edge 25d, and so on, ensuring an alternating sweeping movement of the stationary filtering element rubbing each area of the latter.

The oscillating movement is relatively slow, for example of the order of a few oscillations per minute, but this is sufficient to detach/unstick the cleaning bodies and other elements stopped on the upstream face 25a of the grid 25.

It will be noted that the action of sweeping the upstream face 25a of the filtering surface 25 also has the effect of cleaning the latter at the same time as moving the bodies 15 in order to collect them. The cleaning bodies 15 and other elements captured in the collecting hoppers 27a-c are then aspirated by the pump 41 via the outlet tubes 38 and the branch 49b (FIG. 1).

The water laden with bodies 15 is directed to a unit 60 for management of the cleaning bodies that is already known in itself. This unit 60 enables collection and sometimes counting of the bodies. At the outlet of this unit the water laden with bodies 15 is fed to the body injection pipes 45 disposed upstream of the tubular exchanger 10 to be cleaned.

When circulation of bodies 15 is not used in the installation 1, it is possible specifically to clean the filtering surface 25 (grid) that is encrusted over time with diverse debris fed by the cooling water of the exchanger 10. For this it suffices to keep the pump 41 operating to maintain the oscillatory movement of the member 31. The filtering surface 25 is then cleaned by sweeping it and debris is progressively stored in the ball air lock 44 retained in the position for collecting balls and debris.

The system for interception and collection by alternating mechanical sweeping can function continuously or be operated in defined periods appropriate to the operation of the installation, programmed or otherwise, or even at non-predefined times as a function of the quantity of bodies and other elements stopped by the filtering surface. The sweeping mechanism can be started manually or automatically.

In variants that are not shown:
the system for intercepting and collecting the cleaning bodies can comprise a plurality of filtering elements instead of only one;
the filtering element can be formed of a plurality of portions assembled to one another;
the collecting hoppers can have a different shape and their number and their dimensions can vary;
the obstacles 39 (e.g. deck plates in FIG. 4) can take any form: gutters, etc.;
the drive system 36 can alternatively comprise a piston and cylinder, a rack, a screw, a chain, a belt, etc.;
the perforated side panel 28a, 28c can alternatively be porous.

FIGS. 5 and 6 show a variant of a system for interception and collection by alternating mechanical sweeping in accordance with the invention in which either the filtering surface or the cleaning device is able to effect a movement in rectilinear translation along and against the other element, which is stationary. The filtering surface is plane in this variant.

In these figures the system 117 comprises a flat filtering element 125 (with a plane upstream face 125a and a plane downstream face 125b) installed substantially perpendicularly to the axis X in the body 119 of the sleeve 18. At each of the two opposite peripheral edges 125c, 125d are disposed the collection openings leading into the downstream collection hoppers (the arrangement is identical to that from FIG. 4). Here two collection openings 126a, 126b on the one hand and 126c, 126d on the other hand are provided along each respective peripheral edge 125c, 125d (FIG. 6). The collection hoppers 127a, 127c (FIG. 5) are in the form of vortex chambers equipped with an obstacle 139 generating vortices and one of the two opposite side panels 128a, 128b is for example porous (not necessarily perforated). Tubes 138 are provided in the opposite side of each hopper for the extraction of the cleaning bodies.

The system 117 comprises a device 130 for cleaning by mechanical sweeping that includes a mechanical sweeping member 131 (brush, comb, flexible squeegee, . . . ) which here has the general shape of a scraper. The member 131 extends transversely in the sleeve, parallel to the edges 125c, 125d, and includes a support rod 132 connected to a drive element 136 such as a piston and cylinder, a rack, a screw, a chain, a belt. The drive element 136 moves the member 131 like a piston and the latter adopts a movement in rectilinear translation (perpendicular to the edges 125c, 125d) along the upstream face 125a and rubs/scrapes the latter, in the outward direction, from the edge 125c to the edge 125d (FIGS. 5 and 6) and then in the return direction from the edge 125d to the edge 125c (alternating back and forth movement of the member 131). The bodies stopped by the filtering element 125 are detached/unstuck by the member 131 and pushed by it along the filtering element toward one or other edge 125c, 125d (depending on the direction of movement) and into the adjacent openings whence they are then evacuated via the hoppers and the tubes 138. The alternating sweeping movement can be effected once (outward and return) or a number of times consecutively if necessary (this also applies to the embodiment from FIGS. 1 to 4 and to the variants described above and hereinafter).

The system 117 comprises numerous other elements identical to those of the previous figures that will not be described again here.

The system 117 can be used if the axial space available for the sleeve is limited because the axial overall size of the system is small.

FIG. 7 shows a second way of using the system according to the invention in which the system 17 serves purely as a filter, for example disposed upstream of the exchanger 10 in FIG. 1 to protect it, instead and in place of the filtration means 13.

For convenience elements in FIG. 7 the same as those of the figures for the first embodiment retain the same references.

The outlet pipes 49a, 49b connected to the outlet tubes 38 of the collection hoppers 27a-c are joined to a single pipe 49c equipped with a valve Vch that is connected for example downstream of the exchanger or to the drain (not shown).

The description and the operation of the system 17 are the same as for the first embodiment with the cleaning bodies 15.

The tubes 38 and the pipes 49a-c can have a diameter greater than that used in the FIG. 1 embodiment downstream of the exchanger to extract only the cleaning bodies. This feature enables elimination of the largest debris.

The flow rate leaving the collection hoppers 27a-c is created by the pressure difference in the installation between the upstream side of the exchanger to be protected and for example the downstream side of the latter where the pipe 49c discharges.

FIGS. 8a and 8b show two variants in which the filtering element has a non-plane, for example semicylindrical filtering surface and the cleaning device has the scraper general shape from FIGS. 5 and 6 as seen from above. However, the mechanical sweeping member of the cleaning device extends transversely to the surface with a curved shape corresponding to the curvature of the semicylindrical upstream face of this filtering surface, which enables it to move over and rub on this upstream face. The elements not shown in these figures are identical to those from the other figures or modified for reasons of shape difference.

FIG. 8a shows a filtering surface 140 the upstream face 140a of which is the concave face (inner face) of the semicylindrical filtering element and the cleaning device 142 includes a mechanical sweeping member 144 the only difference in which compared to the member 131 from FIGS. 5 and 6 is its transverse curvature matched to that of the upstream face 140a.

FIG. 8b shows a filtering surface 150 the upstream face 150a of which is the convex face (outer face) of the semicylindrical filtering element and the cleaning device 152 includes a mechanical sweeping member 154 the only difference in which compared to the member 131 from FIGS. 5 and 6 is its transverse curvature matched to that of the upstream face 150a.

All the advantages and features associated with the embodiments and variants from FIGS. 1 to 7 apply equally to the variants from FIGS. 8a and 8b except in the case of technical incompatibility or impossibility.

FIG. 9 shows in axial section a fourth variant of a system 100 for intercepting and collecting cleaning bodies. In this variant the pipe portion or sleeve 118 in which the filtering element (filtering surface) 125 and the cleaning device 130 are housed includes a central body 119 having a cross section of circular general shape. The filtering element 125 is disposed at a distance from the inner face of the pipe portion 118.

The pipe portion 118 comprises the inlet flange 121 and the outlet flange 122.

The filtering surface 125 has a semicylindrical general shape as in FIGS. 1 to 3 with the concave inner face 125a directed upstream (facing into the flow F2). The spaced bars 126 of the filtering grid are shown. The perpendicular bars are not shown here.

The cleaning device 130 is disposed facing the concave inner face 125a and is mobile with an alternating back and forth movement as in FIGS. 1 to 3. The device 130 has the same general configuration as the device 30 with two arms carrying a mechanical sweeping member 131 (only one arm 132b is shown here, as in FIG. 2) and mounted to rotate about a transverse shaft 133. The arm 132b has a section that tapers in the direction of its end connected to the sweeping member.

The filtering surface has two opposite peripheral edges 125c, 125d (the other two perpendicular adjacent opposite edges are cannot be seen here) like the surface 25 from FIG. 2.

A set of collecting hoppers is disposed adjacent each of the edges 125c, 125d downstream of one or more collection openings. Like FIG. 2, FIG. 9 shows two opposite collection hoppers 127a, 127c each connected to an outlet tube 138. Each collection hopper comprises at the inlet an obstacle 139 like the obstacle 39 from FIGS. 2 and 4. It will be noted that a plurality of collection hoppers are disposed one beside the other as in FIG. 4. Cleaning body collection openings 140 are provided downstream of the obstacles 139 and at the level of the edges 125c, 125d. These openings 140 lead into a passage (or trench) 141 on the bottom of which the obstacles 139 are disposed. It will be noted that only one opening 140 is provided adjacent to each edge 125c, 125d for example. These collection openings are disposed upstream of the collection hoppers and are referred to as first collection openings. Second collection openings not shown here are the same as those 26a, 26b from FIG. 4 (around the obstacles 39). The passage 141 between the edges 125c, 125d is higher than that from FIG. 2 and forms as it were the smaller part of a funnel for the cleaning bodies.

The interception and collection system 100 also comprises between the inner face of the pipe portion 118 and the two opposite peripheral edges 125c, 125d of the filtering surface a deflection assembly or deflector assembly. The function of this assembly is to redirect the cleaning bodies conveyed by the flow and near the wall of the pipe portion (and not facing the upstream face of the filtering surface) toward the centre of the pipe portion, i.e. toward the filtering surface, or even directly toward the collection openings 140, depending on the speed and the trajectory of the deviated bodies. This assembly has as it were the role of the flared part of a funnel for the cleaning bodies.

In the present instance the deflection assembly comprises two facing deflectors 145, 146 the surface of which in contact with the bodies is inclined relative to the wall so that the imaginary extension of this surface encounters the collection opening 140. This arrangement enables deviation of the bodies toward the opening.

Each deflector is fixedly mounted on the wall by one or more fixing arms 147, 148 or by a single curved connection element. A bib 149, 150 is fixed to the lower part of each deflector (on the side opposite the contact surface) and extends the contact surface of the latter as far as the collection opening to prevent bodies being able to infiltrate between the deflector and the opening.

As shown in FIG. 9 another deflector 151 is disposed adjacent one of the two other opposite peripheral edges of the filtering surface and a bib 152 is also fixed in the lower part.

This deflector 151 redirects the bodies directly in the direction of the filtering surface. Another deflector not shown in this figure and disposed facing the deflector 151 (symmetrically) is also present in the system.

It will be noted that an axial wall is mounted on and fixed to each of the two other opposite peripheral edges of the filtering surface in order to close the open semicylindrical internal space. The wall 153 in FIG. 9 is one of these two walls and has the general shape of a half-moon.

The deflectors are all exactly the same shape, as shown in FIG. 9, with a rectilinear lower part and a curved upper part that espouses the cylindrical shape of the inner face of the pipe portion 118.

It will be noted that other deflector shapes can alternatively be used, likewise a different number of deflectors. Thus a single peripheral deflector can be used, for example in the form of an annular flange.

The dimensions and/or inclination of the deflectors can also vary. The other features and advantages as well as the operation of the embodiments and variants from the preceding figures apply equally here.

Although the above description of the various modes and variants refers to a mobile cleaning device and a stationary filtering element, this description also suits the opposite situation: a stationary cleaning device and a mobile filtering element.

It will be noted that throughout the foregoing description the cleaning device is formed of a single element. However, the interception and collection system can be duplicated as required and/or include more than one mechanical sweeping member. That member or these members can be mounted mobile relative to their support on the cleaning device.

1. A system for intercepting and collecting bodies conveyed by a flow of a fluid, wherein said system comprises:
a pipe portion comprising an inner face that defines an axial inner passage for the flow of the fluid,
at least one filtering element comprising a filtering surface including a first upstream face and a second opposite downstream face, the filtering surface extending transversely in the inner passage so as to intercept, by its first upstream face, bodies conveyed by the flow whilst leaving exposed a plurality of collection openings between the filtering surface and the inner face of the pipe portion,
a cleaning device that is arranged across from the first upstream face of the filtering surface and that is able to mechanically sweep said first upstream face, the cleaning device and said at least one filtering element being in alternating relative back and forth motion with respect to one another such that each zone of the first upstream face of the filtering surface is swept mechanically by the cleaning device during each alternating relative back and forth movement in order to orient the bodies intercepted by the first upstream face from the filtering surface toward the collection openings for said bodies.

2. The system according to claim 1, wherein the filtering surface has a general shape that extends transversely in the inner passage such that the bodies intercepted on a zone of the first upstream face of the filtering surface and swept by the cleaning device run alongside said first upstream face from the filtering surface toward one or more collection openings.

3. The system according to claim 1, wherein the collection openings are arranged so as to be adjacent to two opposite peripheral edges of the filtering surface.

4. The system according to claim 3, wherein said system comprises, at each of the two opposite peripheral edges of the filtering surface, at least one collection hopper for the bodies arranged downstream from at least one collection opening and communicating with said at least one collection opening.

5. The system according to claim 4, wherein each collection hopper for the bodies forms a vortex chamber including at the inlet at least one obstacle that is able to generate fluid vortices in the chamber when a flow of fluid encounters said at least one obstacle.

6. The system according to claim 1, wherein the filtering surface has a general shape chosen from among the following geometric shapes: a semi-cylindrical surface whereof the concave inner face corresponds to the first upstream face, a semi-cylindrical surface whereof the convex outer face corresponds to the first upstream face, a planar surface formed by a panel substantially perpendicular to the axis of the pipe portion.

7. The system according to claim 3, wherein, when the filtering surface is a semi-cylindrical surface whereof the concave inner face corresponds to the first upstream face, at least one collection opening of the bodies is arranged on either side of said filtering surface, between the inner face of the pipe portion and a peripheral edge of the filtering surface, at least one collection hopper of the bodies being arranged downstream from said at least one collection opening.

8. The system according to claim 1, wherein the pipe portion also comprises the cleaning device.

9. The system according to claim 1, wherein the pipe portion has a polygonal or circular cross-section.

10. The system according to claim 9, wherein the pipe portion having a circular cross-section, the system comprises a deflection assembly that is positioned between the inner face of the pipe portion and the filtering surface in order to steer, toward the filtering surface, the bodies conveyed by the flow and that are not situated across from the filtering surface.

11. The system according to claim 3, wherein the deflection assembly comprises at least one deflector that is positioned between the inner face of the pipe portion and the collection opening(s) arranged so as to be adjacent to each of the two opposite peripheral edges of the filtering surface.

12. The system according to any one of claims 1 to 11, characterized in that the cleaning device is mobile, while said at least one filtering element is stationary, or vice versa.

13. The system according to claim 1, wherein one from among the cleaning device and said at least one filtering element is able to perform a pivoting movement around a fixed axis or to perform a rectilinear translational movement, each movement being an alternating back and forth movement.

14. The system according to claim 1, wherein the cleaning device comprises one or several mechanical sweeping members that are in contact with the first upstream face of the filtering surface.

15. The system according to claim 14, wherein the filtering surface extends in two mutually perpendicular transverse directions, the mechanical sweeping member or members extending transversely in one of the two transverse directions and over all the corresponding dimension of the first upstream face.

16. The system according to claim 3, wherein the mechanical sweeping member or members extends or extend parallel to the two opposite peripheral edges of the filtering surface.

17. System according to claim 14, wherein the filtering surface is formed by a filtration grid with bars defining between them openings through which the fluid flows and in which bodies are liable to be lodged, the mechanical sweeping member or members being able, in contact with the first upstream face of the filtering surface, to penetrate at least partly into the openings of the grid in order to dislodge any bodies lodged there.

18. The system according to claim 1, wherein the bodies conveyed by the flow are heat exchanger cleaning bodies.

19. An installation comprising:
at least one tubular heat exchanger,
a fluid intake pipe connected to an inlet of said at least one heat exchanger,
a fluid discharge pipe connected to an outlet of said at least one heat exchanger,
a plurality of cleaning bodies conveyed inside said at least one heat exchanger for cleaning thereof,
a system for intercepting and collecting cleaning bodies arranged on the fluid discharge pipe,
characterized in that the system for intercepting and collecting cleaning bodies is according to claim 1.

20. A method for collecting bodies conveyed by a flow of a fluid, wherein the method is carried out in a system for intercepting bodies conveyed by the fluid flow that comprises:
a pipe portion comprising an inner face that defines an axial inner passage for the flow of the fluid,
at least one filtering element comprising a filtering surface including a first upstream face and a second opposite downstream face, the filtering surface extending transversely in the inner passage so as to intercept, by its first upstream face, bodies conveyed by the flow while leaving several collection openings clear between the filtering surface and the inner face of the pipe portion,
the method comprising the following step:
setting said at least one filtering element or a cleaning device in motion with respect to said at least one filtering element in an alternating back and forth movement in order to perform mechanical sweeping of each zone of the first upstream face of the filtering surface by contact with the cleaning device opposite, the mechanical sweeping of the surface making it possible to orient the bodies intercepted by the first upstream face from the filtering surface toward the collection openings of said bodies.

21. The method according to claim 20, wherein the cleaning device is set in motion, while said at least one filtering element is stationary, or vice versa.
